(19) United States
(12) Patent Application Publication
(10) Pub. No.: US 2008/0216608 A1
(43) Pub. Date: Sep. 11, 2008

(54) DEVICE FOR REMOVING FUEL INJECTOR SLEEVES AND METHOD THEREFOR

(76) Inventor: Leroy Schuchardt, Las Vegas, NV (US)

Correspondence Address: WEISS & MOY PC, 4204 NORTH BROWN AVENUE, SCOTTSDALE, AZ, 85251, US

(21) Appl. No.: 11/682,709

(22) Filed: Mar. 6, 2007

(51) Int. Cl. B25B 13/48

(52) U.S. Cl. 81/52

(57) ABSTRACT

A device for removing fuel injector sleeves is disclosed. The device allows for the removal of a fuel injector sleeve without dismantling the cab, engine, or head. The device comprises a housing, a threaded rod that engages a threaded aperture defined by a proximal end of the housing and passes through the housing, a fuel injector sleeve remover coupled to a distal end of the threaded rod, and a nut defining a threaded aperture that engages the threaded rod. By twisting the nut about the threaded rod, the fuel injector sleeve remover and fuel injector sleeve is drawn up through a distal end of the housing and into the housing.

### FIELD OF THE INVENTION

This invention relates generally to engines and, more specifically, to a device for removing fuel injector sleeves.

### BACKGROUND OF THE INVENTION

Fuel injector sleeves often become corroded and cracked and require replacement. After the fuel injector sleeve is threaded with a tap, a slide hammer is typically used to remove the fuel injector sleeve. However, because the slide hammer is so large and cumbersome, a person will need to remove the cab, engine, or head in order to access the fuel injector sleeve. This process is time consuming and requires that the vehicle be partially dismantled in order to replace the small fuel injector sleeve.

Therefore a need exists for an improved device that will allow for removing fuel injector sleeves from an engine. The device will allow a person to access and remove the fuel injector sleeve without having to dismantle the cab, engine, or head.

### SUMMARY OF THE INVENTION

An object of the present invention is to provide an improved device for removing fuel injector sleeves.

Another object of the present invention is to provide a device that will allow a person to remove a fuel injector sleeve without having to dismantle the cab, engine, or head.

### BRIEF DESCRIPTION OF THE PREFERRED EMBODIMENTS

In accordance with one embodiment of the present invention, a device for removing a fuel injector sleeve is disclosed. The device comprises a housing, a threaded rod that engages a threaded aperture defined by a proximal end of the housing and passes through the housing, a fuel injector sleeve remover coupled to a distal end of the threaded rod, and a nut defining a threaded aperture that engages the threaded rod.

In accordance with another embodiment of the present invention, a device for removing a fuel injector sleeve is disclosed. The device comprises a housing that has a length of approximately 3 inches, that has a proximal end defining a threaded aperture having a diameter of approximately ⅝ inch, and that has a distal end that has an inner diameter of approximately 1⅝ inches, and that has an outer diameter of approximately 1⅞ inches; a threaded rod that has a diameter of approximately ⅝ inch, that has a length of between approximately 3.5 inches and approximately 5 inches, and that engages the threaded aperture defined by the proximal end of the housing and passes through the housing; a fuel injector sleeve remover having a length of approximately 4 inches and having a width of approximately 1.5 inches, the fuel injector sleeve remover being coupled to a distal end of the threaded rod; and a nut defining a threaded aperture that engages the threaded rod, the threaded aperture having a diameter of approximately ⅝ inch.

In accordance with another embodiment of the present invention, a method of removing a fuel injector sleeve is disclosed. The method comprises the steps of: providing a device for removing a fuel injector sleeve comprising a housing, a threaded rod that engages a threaded aperture defined by a proximal end of the housing and passes through the housing, a fuel injector sleeve remover coupled to a distal end of the threaded rod, and a nut defining a threaded aperture that engages the threaded rod; coupling a threaded distal end of the fuel injector sleeve remover to a threaded proximal end of the fuel injector sleeve; twisting the nut about the threaded rod until the nut contacts the proximal end of the housing; and twisting the nut about the threaded rod to draw the fuel injector sleeve remover up through a distal end of the housing and into the housing.

The foregoing and other objects, features, and advantages of the present invention will be apparent from the following, more particular, description of the preferred embodiments of the invention, as illustrated in the accompanying drawings.

### BRIEF DESCRIPTION OF THE DRAWINGS

FIG. 1 is a cross-sectional view of the device of the present invention, shown in use removing a fuel injector sleeve from a cylinder.

FIG. 1a is an exploded view of the device of FIG. 1.

FIG. 2 is a cross-sectional view of the device of FIG. 1, shown with the fuel injector sleeve remover being pulled up and into a distal end of the housing.

FIG. 3 is an exploded view of another embodiment of the device of the present invention, wherein the fuel injector sleeve remover is integral to the threaded rod.

FIG. 3a is a perspective view of a proximal end of the threaded rod.

FIG. 4 is a cross-sectional view of the device of FIG. 3, shown in use removing a fuel injector sleeve from a cylinder.

FIG. 5 is a perspective view of the device of FIG. 3 shown removing a fuel injector sleeve from an engine cylinder.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

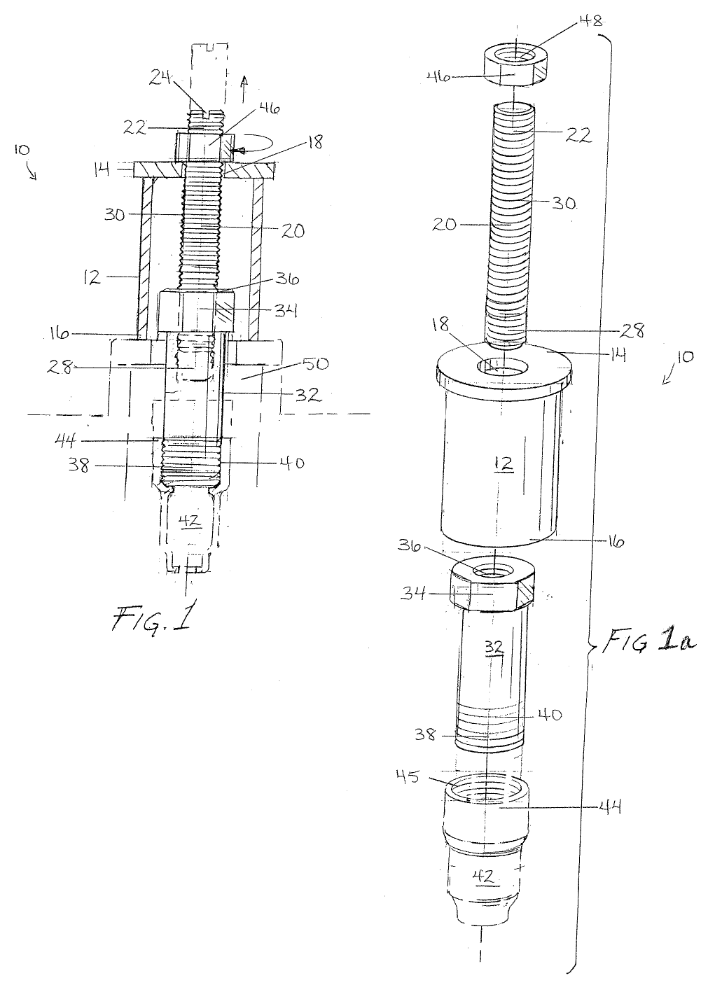

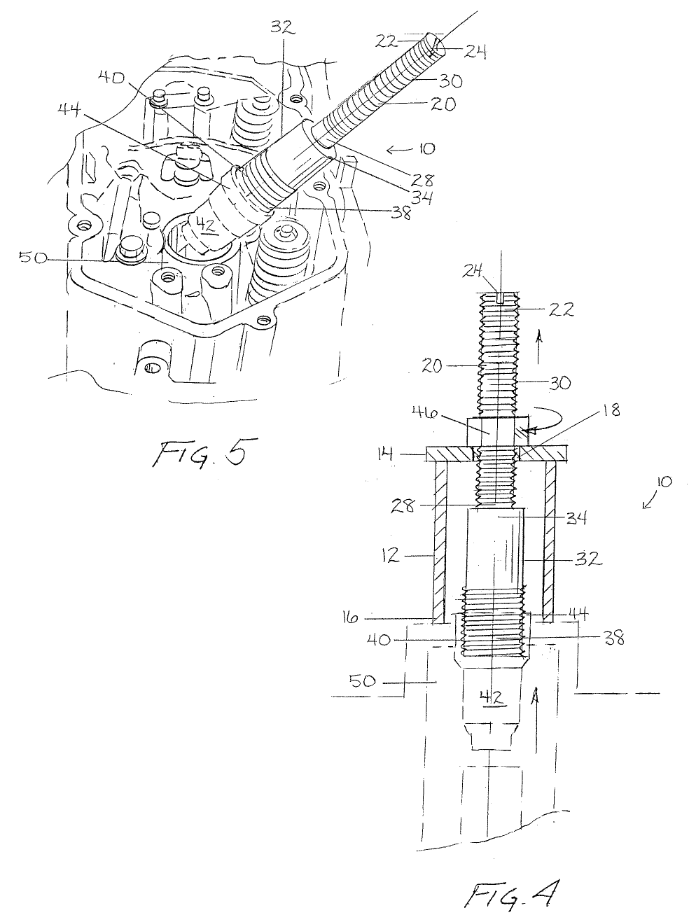

FIGS. 1-5 together disclose a device 10 for removing fuel injector sleeves from an engine. The device comprises a housing 12, a threaded rod 20, a fuel injector sleeve remover 32, and a nut 46. When the fuel injector sleeve remover 32 is coupled to a fuel injector sleeve 42, the nut 46 is twisted about the threaded rod 20 to draw the fuel injector sleeve remover 32 up into the housing 12 and the fuel injector sleeve 42 out of the engine cylinder 50.

A proximal end 14 of the housing 12 defines a threaded aperture 18. The threaded rod 20 is dimensioned to engage the threaded aperture 18 and to pass through the housing 12 and out of a distal end 16 of the housing 12. The housing 12 is preferably approximately 3 inches long and the distal end 16 preferably has an inner diameter of approximately 1⅝ inches and an outer diameter of approximately 1⅞ inches. However, it should be clearly understood that substantial benefit may be derived from the housing 12 having different dimensions so long as the housing 12 is sized to sit just above the head of the cylinder 50.

The nut 46 defines a threaded aperture 48 and is dimensioned engage the threaded rod 20. Preferably, the threaded aperture is approximately ⅝ inch in diameter. However, it should be clearly understood that substantial benefit may be derived from the threaded aperture 48 having a different diameter so long as the nut is dimensioned to engage the threaded rod 20.

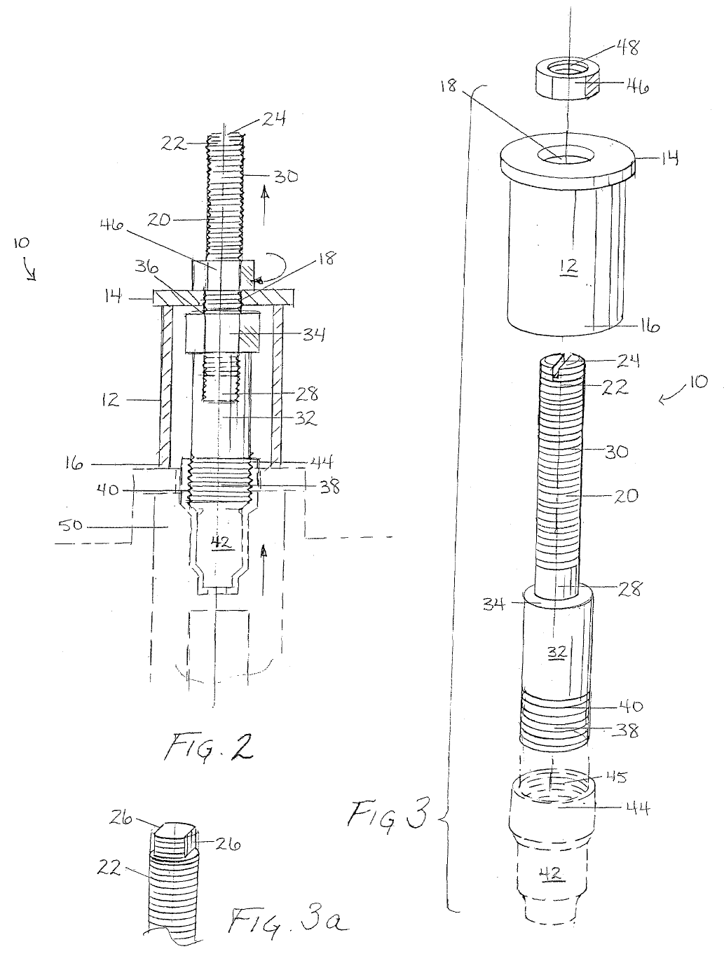

A proximal end 22 of the threaded rod 20 will preferably define a slit 24 which may be engaged by a flat head screwdriver (not shown). The screwdriver may be used to twist the threaded rod 20. Further preferably, the proximal end 22 of the threaded rod 20 may also have at least two opposing flat sides 26 (shown in FIG. 3a), which may be engaged by a wrench (not shown). The proximal end 22 of the threaded rod 20 may define a slit 24 only, may have only opposing flat sides 26, may have both the slit 24 and opposing flat sides 26, or may have neither.

The distal end of 28 of the threaded rod 20 may be removably coupled to the proximal end 34 of the fuel injector sleeve remover 32 (see FIGS. 1-2) or the distal end 28 of the threaded rod 20 may be integral to the proximal end 34 of the fuel injector sleeve remover 32 (see FIGS. 3, 4, and 5). The threaded rod 20 may be between approximately 3.5 inches and approximately 5 inches long. It should be clearly understood, however, that substantial benefit may be derived from the threaded rod 20 having a different length, as long as the threaded rod 20 is long enough to have its proximal end 22 protrude out of the threaded aperture 18 of the housing 12 and to have its distal end 28 protrude out of the distal end 16 of the housing 12 and be coupled to the proximal end 34 of the fuel injector sleeve remover 32.

Where the threaded rod 20 is removably coupled to a fuel injector sleeve remover 32, the standard sized fuel injector sleeve remover will have a proximal end 34 that defines a threaded aperture 36. In order to engage this standard sized fuel injector sleeve remover 32, the threaded rod 20 will preferably have a thread 30 of approximately 1.25 inch by 20. It is further preferable that the threaded rod 20 has a diameter of approximately ⅝ inch and that the threaded aperture 18 defined by the proximal end 14 of the housing 12, correspondingly, be approximately ⅝ inch in diameter. But, it should be clearly understood that further substantial benefit may be derived from the threaded aperture 18 and threaded rod 20 having a different diameter size, so long as the threaded rod 20 is dimensioned to engage and pass through the threaded aperture 18 defined by the proximal end 14 of the housing 12. It should be further understood that substantial benefit may be derived from the threaded rod 20 having a thread 30 of a different size, as long as the threaded rod 20 is able to engage the threaded aperture 36 defined by the proximal end 34 of the fuel injector sleeve remover 32.

The fuel injector sleeve remover 32, whether integral to or removably coupled to the threaded rod 20, will preferably have a length of approximately 4 inches and have a width of approximately 1.5 inches. However, it should be clearly understood that further substantial benefit may be derived from the fuel injector sleeve remover 32 having a different length and/or width, so long as the fuel injector sleeve is dimensioned to be coupled to a fuel injector sleeve 42 and is dimensioned to be received within the housing 12. The thread 40 of the fuel injector sleeve remover 32 will preferably be approximately 1.25 inch by 20 because a tap (not shown) is typically used to create 1.25 inch by 20 threads 45 in the proximal end 44 of the fuel injector sleeve 42. It should be clearly understood that substantial benefit may be derived from the fuel injector sleeve remover 32 having a different size thread 40 so long as it is dimensioned to engage the thread 45 created by the tap in the proximal end 44 of the fuel injector sleeve 42.

### Statement of Operation

In order to use the device 10 of the present invention, a tap must be used to create threads 45 in the proximal end 44 of the fuel injector sleeve 42. The distal end 38 of the fuel injector sleeve remover 32 must then be coupled to the proximal end 44 of the fuel injector sleeve 42 by twisting the fuel injector sleeve remover 32 so that the threads 40 on the distal end 38 of the fuel injector sleeve remover 32 engage the threads 45 in the proximal end 44 of the fuel injector sleeve 42.

If the threaded rod 20 is integral to the fuel injector sleeve remover 32, then twisting the threaded rod 20 will cause the fuel injector sleeve remover 32 to couple to the fuel injector sleeve 42. If the threaded rod 20 is removably coupled to the fuel injector sleeve remover 32, then the threaded rod 20 must be twisted so that the thread 30 of the threaded rod 20 will engage the threaded aperture 36 defined by the proximal end 34 of the fuel injector sleeve remover 32.

The proximal end 22 of the threaded rod 20 must protrude out of the threaded aperture 18 defined by the proximal end 14 of the housing 12. The nut 46 will then be twisted about the threaded rod 20 until the nut 46 contacts the proximal end 14 of the housing 12. By continuing to twist the nut 46 about the threaded rod 20, the fuel injector sleeve remover 32 will be drawn up through the distal end 16 of the housing 12 and into the housing 12, thereby removing the fuel injector sleeve 42 from the cylinder 50.

While the invention has been particularly shown and described with reference to preferred embodiments thereof, it will be understood by those skilled in the art that the foregoing and other changes in form and details may be made therein without departing from the spirit and scope of the invention.

I claim:

1. A device for removing a fuel injector sleeve comprising:
a housing;
a threaded rod that engages a threaded aperture defined by a proximal end of the housing and passes through the housing;
a fuel injector sleeve remover coupled to a distal end of the threaded rod; and
a nut defining a threaded aperture that engages the threaded rod.

2. The device of claim 1 wherein the housing is dimensioned to receive the fuel injector sleeve remover through a distal end of the housing.

3. The device of claim 1 wherein the housing is approximately 3 inches long.

4. The device of claim 1 wherein the threaded aperture defined by the proximal end of the housing has a diameter of approximately ⅝ inch.

5. The device of claim 4 wherein the threaded rod has a diameter of approximately ⅝ inch.

6. The device of claim 1 wherein the threaded rod is between approximately 3.5 and approximately 5 inches long.

7. The device of claim 1 wherein the threaded rod has a thread of approximately 1.25 inch by 20.

8. The device of claim 1 wherein a proximal end of the threaded rod defines a slit.

9. The device of claim 1 wherein a proximal end of the threaded rod has at least two opposing flat sides.

10. The device of claim 1 wherein a distal end of the fuel injector sleeve remover has a thread of approximately 1.25 inch by 20.

11. The device of claim 1 wherein a proximal end of the fuel injector sleeve remover is integral to the distal end of the threaded rod.

12. The device of claim 11 wherein the fuel injector sleeve remover is approximately 4 inches long.

13. The device of claim 1 wherein a proximal end of the fuel injector sleeve remover is removably coupled to the distal end of the threaded rod.

14. The device of claim 13 wherein the distal end of the threaded rod engages a threaded aperture defined by the proximal end of the injector sleeve remover.

15. A device for removing a fuel injector sleeve comprising:
a housing that has a length of approximately 3 inches, that has a proximal end defining a threaded aperture having a diameter of approximately ⅝ inch, and that has a distal end that has an inner diameter of approximately 1⅝ inches, and that has an outer diameter of approximately 1⅞ inches;
a threaded rod that has a diameter of approximately ⅝ inch, that has a length of between approximately 3.5 inches and approximately 5 inches, and that engages the threaded aperture defined by the proximal end of the housing and passes through the housing;
a fuel injector sleeve remover having a length of approximately 4 inches and having a width of approximately 1.5 inches, the fuel injector sleeve remover being coupled to a distal end of the threaded rod; and
a nut defining a threaded aperture that engages the threaded rod, the threaded aperture having a diameter of approximately ⅝ inch.

16. The device of claim 15 wherein a proximal end of the fuel injector sleeve remover is integral to the distal end of the threaded rod.

17. The device of claim 15 wherein a proximal end of the fuel injector sleeve remover is removably coupled to the distal end of the threaded rod.

18. A method of removing a fuel injector sleeve comprising the steps of:
providing a device for removing a fuel injector sleeve comprising:
a housing;
a threaded rod that engages a threaded aperture defined by a proximal end of the housing and passes through the housing;
a fuel injector sleeve remover coupled to a distal end of the threaded rod; and
a nut defining a threaded aperture that engages the threaded rod;
coupling a threaded distal end of the fuel injector sleeve remover to a threaded proximal end of the fuel injector sleeve;
twisting the nut about the threaded rod until the nut contacts the proximal end of the housing; and
twisting the nut about the threaded rod to draw the fuel injector sleeve remover up through a distal end of the housing and into the housing.

19. The device of claim 18 wherein the proximal end of the fuel injector sleeve remover is integral to the distal end of the threaded rod.

20. The device of claim 18 wherein the proximal end of the fuel injector sleeve remover is removably coupled to the distal end of the threaded rod.
